(19) United States
(12) Patent Application Publication
(10) Pub. No.: US 2013/0015022 A1
(43) Pub. Date: Jan. 17, 2013

(54) DETERMINING SHAFT INFORMATION

(71) Applicants: Astrid Sonnenmoser, Ebikon (CH); Christian Studer, Luzern (CH)

(72) Inventors: Astrid Sonnenmoser, Ebikon (CH); Christian Studer, Luzern (CH)

(21) Appl. No.: 13/546,025

(22) Filed: Jul. 11, 2012

(30) Foreign Application Priority Data
Jul. 13, 2011 (EP) 11173791.2

(51) Int. Cl. B66B 3/02

(52) U.S. Cl. 187/394

(57) ABSTRACT

Information equipment arranged in an elevator shaft generates shaft information with respect to movement of an elevator cage in the elevator shaft, wherein a code arranged at a hanging cable and readable by means of a reader provides information for generation of the shaft information. The hanging cable conducts energy and signals to the elevator cage and signals from the elevator cage to an elevator control and at the same time serves as a carrier for the code for generation of the information.

### CROSS-REFERENCE TO RELATED APPLICATION

This application claims priority to European Patent Application No. 11173791.2, filed Jul. 13, 2011, which is incorporated herein by reference.

### FIELD

The disclosure relates to shaft information for an elevator.

### BACKGROUND

Equipment for generation of shaft information in an elevator shaft has become known from the specification US 2006/0118364 A1. A strip extending over the shaft height serves as a carrier for a code. At least one reader is arranged at an elevator cage movable in the shaft and reads the code during movement over the strip. The reader generates therefrom a signal which reflects the position of the elevator cage in the elevator shaft and which is passed on by means of a hanging cable to the elevator control. Mounting of the strip can be costly in terms of material and working hours and can require additional space in the elevator shaft.

### SUMMARY

In at least some embodiments, an information system can be constructed without additional working hours and without additional material apart from a reader. In further embodiments, the information system does not need any additional space in the elevator shaft. The code needed for the generation of information can be mounted at the factory or on site at a hanging cable. The hanging cable conducts energy and signals to the elevator cage and signals from the elevator cage to the elevator control and at the same time serves as a carrier for the code for the generation of the information.

When the information device is placed in operation a learning travel is performed and the hanging cable or the code is read by means of a reader arranged at the elevator cage and the thus-obtained information is stored. If in the course of operation the code is dirtied or damaged, the information equipment can reconstruct the failed code by means of the stored information and, for example, log a fault report or a maintenance report. In operation, the elevator cage travels up and down, wherein in each instance the hanging cable, which is travelled over, or the code, which is travelled over, at the hanging cable is detected by means of the reader and the position of the elevator cage determined. Monitoring functions can also be undertaken by the information device and by the code, The code can, for example, contain information relating to excess speed of the elevator cage or information relating to deviation of the elevator cage from the story level at a story stop or information relating to travel beyond the shaft end, etc.

### BRIEF DESCRIPTION OF THE DRAWINGS

The present disclosure is explained in more detail by way of the accompanying figures, in which:

FIG. 1 shows elevator equipment with an information device,

FIG. 2 shows a hanging cable with a twin-track code,

FIGS. 3 and 4 show details of the code,

FIG. 5 shows a guide device for the hanging cable,

FIG. 6 shows a second fixing point for stabilization of the hanging cable,

FIG. 7 shows a guide device with a U-profile and

FIG. 8 shows a guide device with an eye.

### DETAILED DESCRIPTION

FIG. 1 shows an elevator cage 2 movable in an elevator shaft 1. The elevator cage 2 is guided along guide rails, which are not illustrated. A hanging cable 3 conducts energy and signals to the elevator cage 2 and signals from the elevator cage 2 to an elevator control 2.1. The hanging cable 3 usually consists of a flat, strip-like casing which encloses a plurality of mutually adjacent electrical conductors. Other forms of hanging cable on which a code can be mounted are also possible, for example a cable with a semi-circular cross-section.

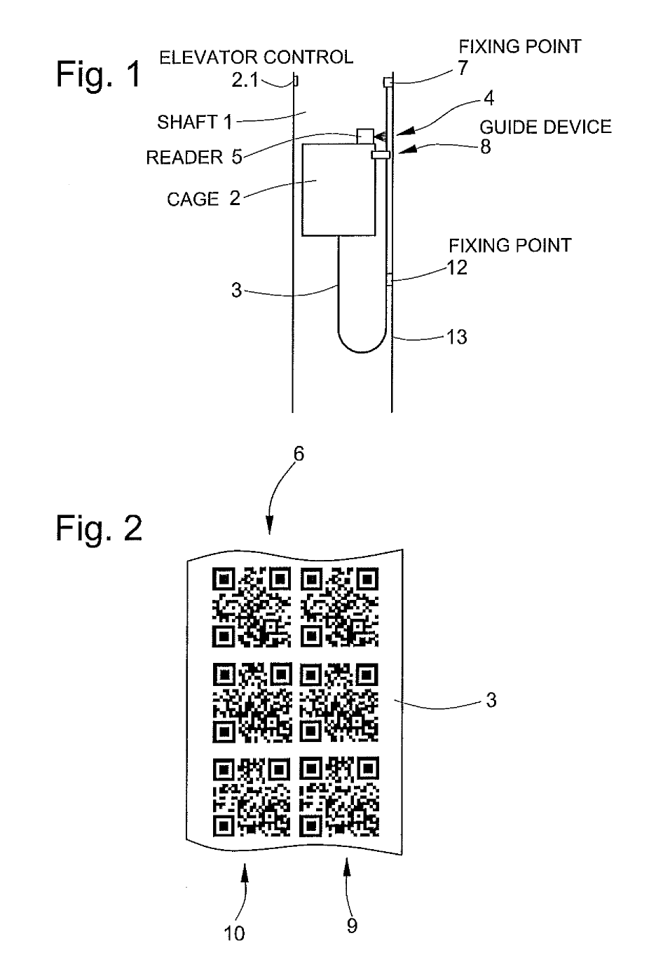

An information device 4 generates shaft information, which is used by a control device for control of the cage movement and the cage position and/or the counterweight movement and/or the counterweight position. The shaft information comprises, for example, the speed and/or the position in the elevator shaft 1 of the elevator cage 2 and/or of a counterweight. The information device 4 in the illustrated example consists of at least one reader 5 and at least one code 6 arranged at the hanging cable 3, as is shown in FIG. 2. The hanging cable 3 is fastened at one end to a fixing point 7 and at the other end to the elevator cage 2. The hanging cable 3 is guided by means of a guide device 8 arranged at the elevator cage 2. During movement of the elevator cage 2 the hanging cable 3 or the code 6 moves smoothly, with lateral stability and at a constant spacing past the reader 5.

FIG. 2 shows the code 6 arranged at the hanging cable 3. The code 6 consists of two-dimensional code patterns 2D, which are arranged in a first track 9 and in a second track 10. The code 6 can, for example, be glued, printed or lasered onto the hanging cable 3.

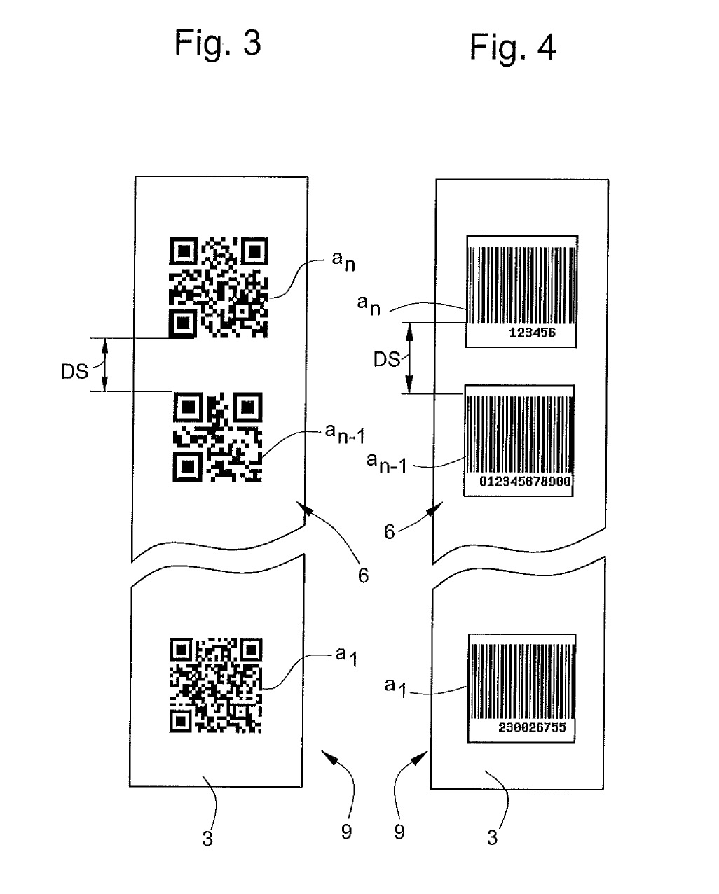

FIG. 3 shows details of the code 6 which is shown in FIG. 2 and consists of code patterns. Each code pattern consists of a checkered arrangement of fields, wherein each field is black or white depending on the respective information content of the code pattern. The reader 5 can recognize the image from black and white fields and determine the information content therefrom. A first code pattern at the hanging cable 3 is denoted by a₁, for example the lowermost code pattern at the hanging cable 3 when the elevator cage 2 has travelled downwardly slightly beyond the lowermost story. A second-to-last code pattern is denoted by aₙ₋₁, for example a second-to-uppermost code pattern of the hanging cable 3, and a last code pattern is denoted by aₙ, for example an uppermost code pattern of the hanging cable 3, when the elevator cage 2 has travelled upwardly slightly beyond the uppermost story.

The code patterns 1₁ to aₙ are different because each code pattern has a different information content. Included in the lowermost code pattern a₁ and in the uppermost code pattern aₙ is or are, for example, the position of the code pattern and/or information for triggering an emergency stop. Door positions can also be included in the code patterns. The code patterns between the lowermost code pattern a₁ and the uppermost code pattern aₙ are arranged at the hanging cable 3 at a specific spacing DS from the adjacent code pattern and include at least one item of information with respect to the respective position of the code pattern a₁ . . . aₙ or form a readable scale, which extends over the travel path of the elevator cage 2, in code form.

The information with respect to the position of the code pattern can also be present twice in each code pattern a₁ . . . aₙ, once for travel of the elevator cage 2 in upward direction and once for travel of the elevator cage 2 in downward direction.

FIG. 4 shows an embodiment of a code 6 with one-dimensional code patterns 1D. Each code pattern consists of a readable barcode. The explanations with respect to the code patterns of FIG. 3 also apply to the code patterns of FIG. 4.

A code 6 with only one track is also possible. A certain degree of redundancy is nevertheless provided, because the reader 5 has at the same time more than one code pattern in focus. If a code pattern is dirtied or damaged or unreadable for other reasons, the information content of the unreadable code pattern can be reconstructed or reproduced from the adjacent code patterns. In addition, a fault report or a maintenance report can be generated and logged.

If the elevator cage 2 is located at the top in the elevator shaft 1 the length of the hanging cable 3 at the cage side is large and the length of the hanging cable at the shaft wall side is small. If the elevator cage 2 is located at the bottom in the elevator shaft 1 the length of the hanging cable 3 at the cage side is small and the length of the hanging cable at the shaft wall side is large. The length of the hanging cable 3 at the shaft wall side and thus the length of the hanging cable 3 at which the reader 5 reads the code 6 changes depending on the respective position of the elevator cage 2. Depending on the respective length of the elevator cable 3 on the shaft wall side this hanging cable section stretches to a greater or lesser extent, which has a direct influence on the accuracy of the code 6 in terms of position. However, the influence of the stretching on the accuracy in terms of position is small. For example, in the case of a shaft height of 40 meters the difference is approximately 2.5 millimeters. The difference is independent of the cage load and can, for example, be measured in the case of a learning travel with respect to the door position of the lowermost story door. The influence of the stretching on the measurement accuracy can also be subject to computerized correction in that a computed length change can be additionally added to the measured position.

The same applies to the speed of the elevator cage 2. However, the stretching of the hanging cable 3 produces merely a negligible difference in the speed of the elevator cage 2.

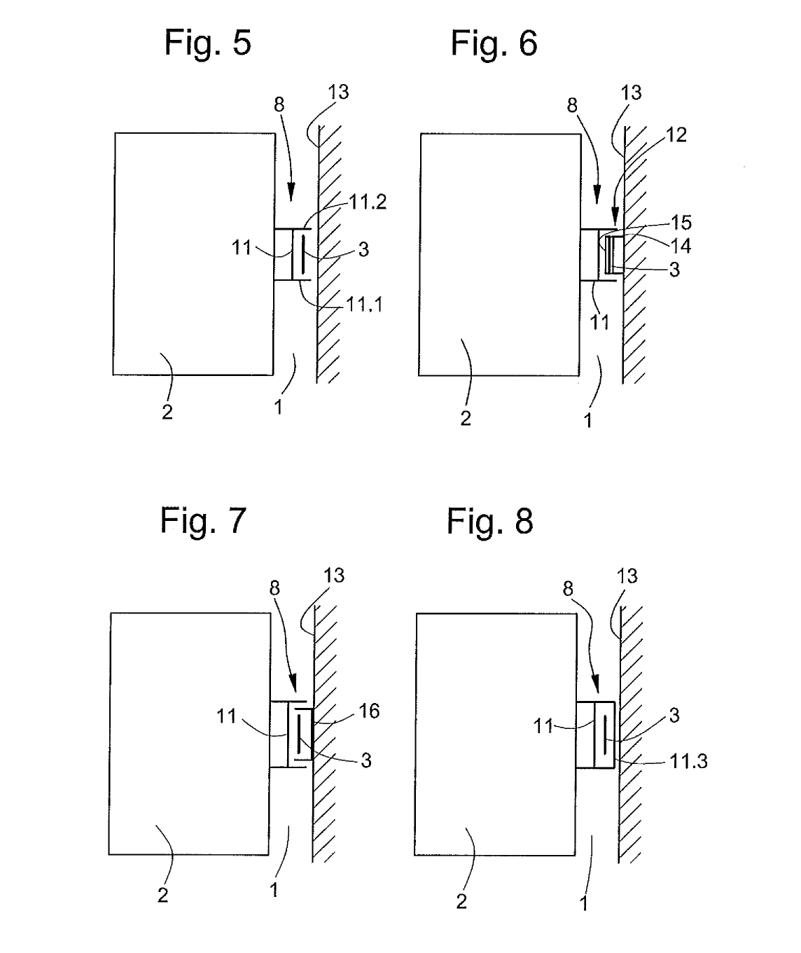

FIG. 5 shows details of the guide device 8 for guidance of the hanging cable 3 during the movement of the elevator cage 2. As is shown in FIG. 1, the guide device 8 is arranged at the elevator cage 2 in the vicinity of the reader 5. During movement of the elevator cage 2 the free hanging cable 3 or the code 6 moves smoothly, with lateral stability and at constant spacing past the reader 5. A guide shoe 11 arranged at the elevator cage 2 guides, by a first free limb 11.1 and a second free limb 11.2, the hanging cable 2 past the reader 5.

The guide shoe 11 according to FIG. 5 can also be used if the hanging cable 3 is connected in the middle of the elevator shaft 1 at a second fixing point 12 with, for example, a shaft wall 13. The hanging cable 3 fits in a profile member 14 arranged at the shaft wall 13 and is fixed at the profile 14 by a mount 15 secured to the profile member 14. The mount 15 can be, for example, a yoke fitting between two code patterns or a transparent cover fitting on the profile member 14.

FIG. 7 shows a guide device 8 in which the hanging cable 3 is laterally guided over the entire shaft height by means of a U-shaped profile member 16. The guide shoe 11 embraces the U-shaped profile member 16 by the free limbs 11.1 and 11.2 and helps ensure that the hanging cable 3 does not leave the U-shaped profile member 6.

FIG. 8 shows a guide shoe 11 in which the free limbs 11.1, 11.2 together with the web 11.3 form an eye in which the hanging cable 3 is guided all round. This form of guidance is independent of the shaft wall, but may not be suitable if a second fixing point 12 is provided centrally of the shaft.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. We therefore claim as our invention all that comes within the scope and spirit of these claims.

We claim:

1. An elevator device comprising:
a cable for conducting energy to an elevator cage and for carrying signals between the elevator cage and an elevator control, the cable having a code on it; and
a reader for reading the code as the elevator cage moves in a shaft.

2. The elevator device of claim 1, the code comprising a plurality of code patterns distributed over length of the cable.

3. The elevator device of claim 2, the code patterns comprising one-dimensional code patterns.

4. The elevator device of claim 2, the code patterns comprising two-dimensional code patterns.

5. The elevator device of claim 2, the plurality of code patterns being separated from each other over the length of the cable by a defined spacing.

6. The elevator device of claim 1, further comprising a guide device for the cable, the guide device being couplable to the elevator cage.

7. An elevator method, comprising:
moving an elevator car in a shaft, the elevator car being coupled to a hanging cable, the hanging cable having a code on it; and
using a reader, reading the code from the hanging cable while the elevator car moves in the shaft, the reader being positioned on the elevator car.

8. The elevator method of claim 7, further comprising generating shaft information based on the read code.

9. The elevator method of claim 7, the moving the elevator car in the shaft being performed during a learning travel.

10. The elevator method of claim 7, further comprising reconstructing stored information in a dirtied or damaged portion of the code based on information from a learning travel.

11. The elevator method of claim 10, further comprising logging a maintenance report.

12. An elevator installation, comprising:
an elevator cage disposed in a shaft;
a cable coupled to the elevator cage for carrying signals between the elevator cage and an elevator control, the cable having a code on it; and
a reader for reading the code as the elevator cage moves in the shaft, the reader being coupled to the elevator cage.

13. An elevator cable comprising:
a signal cable for carrying signals between an elevator cage and an elevator control; and
a code arranged on the signal cable.
